(19) United States
(12) Patent Application Publication
(10) Pub. No.: US 2026/0367826 A1
(43) Pub. Date: Nov. 19, 2026

(54) ONE TIME PROGRAMMABLE DEVICE WITH TESTING FLEXIBILITY

(71) Applicant: Ambiq Micro, Inc., Austin, TX (US)

(72) Inventors: Daniel Cermak, Austin, TX (US); Jayesh Shah, Austin, TX (US)

(21) Appl. No.: 19/678,712

(22) Filed: May 15, 2026

Related U.S. Application Data
(60) Provisional application No. 63/807,293, filed on May 16, 2025.

(51) Int. Cl. G06F 3/06

(52) U.S. Cl. CPC G06F 3/0655; G06F 3/0604; G06F 3/0679

(57) ABSTRACT

A method of determining the source of critical data such as trim values by a microcontroller on a device. The device includes a one time programmable device that has a first partition that stores a first set of critical data. The one time programmable device has a first monotonic counter including a plurality of bits. A first bit in the monotonic counter is written to set a first counter value. Based on the first counter value, the first set of critical data in the first partition is accessed by the microcontroller. A second bit in the monotonic counter is written to set a second counter value. Based on the second counter value, the microcontroller accesses a second set of critical data from an external memory device instead of the first set of critical data in the first partition.

### PRIORITY CLAIM

The present disclosure claims priority to and the benefit of U.S. Provisional Serial No. 63/807,293 filed May 16, 2025. The contents of that application are hereby incorporated by reference in their entirety.

### TECHNICAL FIELD

The present invention relates generally to flexible access to critical data for system on chip devices. More specifically, a one time programmable (OTP) memory with a monotonic counter to direct a system to reference either the OTP memory or an alternative storage for reading critical data is disclosed.

### Background

In recent years, due to the growth of portable electronics, there has been a push to decrease the power used by microcontrollers (or “MCU”), microprocessors, application processors, digital signal processors (DSPs), neural processing units (NPUs), and other circuits used in portable electronic appliances. With lower power requirements, effective electronics operation time can be extended, or alternatively, smaller batteries can be used. Commonly, the power consumption of a microcontroller and associated circuits may be reduced by using a lower supply voltage, or by reducing the amount of internal capacitance being charged and discharged during the operation of the circuit.

One method for reducing microcontroller power relies on hardware or software-based power mode switching. Power modes can be selected for microcontroller components or resources based on operating state, operating conditions, and/or sleep cycle characteristics and other factors to configure low power modes for selected microcontroller components at the time the processor enters a low power or sleep state. In some systems, a set of predefined low power configurations can be used, while more sophisticated systems can dynamically select low power configurations to maximize power savings while still meeting system latency requirements.

One Time Programmable (OTP) memory, typically supported via an eFuse/anti-fuse or non-volatile memory arrays, is used for storing data such as critical trims or security information (e.g., cryptographical keys) on system on chip devices. Trims may be used by the microcontroller to fine tune components to conserve power. Fuses provide higher level of security/robustness for sensitive storage as they cannot be tampered with. However, one time programmability capability creates a challenge when a device is under test or under a validation or return merchandise authorization (RMA) process since in these circumstances, the bits storing the data typically need to be re-programmed for purposes of testing, validation or an RMA process. Another challenge is when trims need to be patched after the system on chip devices have been shipped to customers.

Thus, there is a need for a one time programmable (OTP) memory that includes bits that allow designation for using critical data stored in the OTP memory or using other critical data stored in another source for operations of a system on chip device offered by a silicon vendor. There is another need for a flexible access of permanently stored data in an OTP memory throughout the product life cycle of a system on chip based product offered by an original equipment manufacturer (OEM).

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a one time programmable memory device is disclosed. The device has a first partition storing a first set of critical data. The device includes a first monotonic counter including a plurality of bits that may be incrementally written to direct reading the first set of critical data from the first partition or reading a second set of critical data from an alternative memory device.

A further implementation of the example device is where the alternative memory device is a non-volatile memory. Another implementation is where the alternative memory device is one of a memory on a system on chip, the system on chip including the one time programmable memory, or a memory external to the system on chip. Another implementation is where the first set of critical data includes one of device trim values or security information, and where the second set of critical data includes different one of device trim values or security information. Another implementation is where the device trims include trims for one of an analog to digital converter, a microphone, a power regulator, or a clock. Another implementation is where the security information includes one of an access code, a cryptographical key, a configuration for an update of device firmware, version information for a secure boot loader firmware, or a device recovery configuration. Another implementation is where the device includes a second partition storing a third set of critical data. The device includes a second monotonic counter including a plurality of bits that may be incrementally written to direct reading the third set of critical data from the second partition or reading a fourth set of critical data from an alternative memory device. Another implementation is where the first partition is accessible by a system on chip vendor and the second partition is accessible by a product OEM. Another implementation is where the one time programmable memory device is an e-fuse. Another implementation is where the first partition stores an address to a patch for one of a plurality of trims, where a patch is received by a hardware device that accesses the one time programmable device.

Another disclosed aspect is a method of determining a location of critical data for a system on chip device including a microcontroller and a one time programmable device having a first partition and a first monotonic counter including a plurality of bits. A first set of critical data is written in the first partition. A first bit in the monotonic counter is written to set a first counter value. Based on the first counter value, the first set of critical data in the first partition is accessed by the microcontroller. A second bit in the monotonic counter is written to set a second counter value. Based on the second counter value, a second set of critical data is accessed from an alternative memory device by the microcontroller instead of the first set of critical data in the first partition.

A further implementation of the example method is where the alternative memory device is a non-volatile memory. Another implementation is where the alternative memory device is one of another memory on the system on chip or a memory external to the system on chip. Another implementation is where the first set of critical data includes one of device trim values or security information, and wherein the second set of critical data includes different one of device trim values or security information. Another implementation is where the device trims include trims for one of an analog to digital converter, a microphone, a power regulator, or a clock, and where the security information includes one of an access code, a cryptographical key, a configuration for an update of device firmware, version information for a secure boot loader firmware, or a device recovery configuration. Another implementation is where the example method includes storing a third set of critical data in a second partition of the one time programmable device; and incrementally writing a bit of a second monotonic counter including a plurality of bits to direct reading the third set of critical data from the second partition or reading a fourth set of critical data from an external memory device. Another implementation is where the first partition is accessible by a system on chip vendor and the second partition is accessible by a product OEM. Another implementation is where the one time programmable memory device is an e-fuse. Another implementation is where the example method includes storing an address to a patch for one of a plurality of trims; and receiving the patch by a hardware device that accesses the one time programmable device.

Another disclosed aspect is a system on chip device including a microcontroller and a one time programmable memory device accessible by the microcontroller. The one time programmable memory device includes a first partition storing a first set of critical data and a first monotonic counter. The first counter includes a plurality of bits that may be incrementally written to direct the microcontroller to read the first set of critical data from the first partition or read a second set of critical data from an alternative memory device.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure will be better understood from the following description of exemplary embodiments together with reference to the accompanying drawings, in which:

FIG. 1 is a diagram of a system on chip in an energy efficient product that provides near threshold voltages for powering various components;

FIG. 2 is a block diagram of the example system on chip device shown in FIG. 1;

FIG. 3A is a block diagram of an example one-time programmable memory in FIG. 1 that allows flexibility of accessing critical data for testing and other processes by a system on chip device vendor;

FIG. 3B is a block diagram of the example one-time programmable memory in FIG. 1 that allows flexibility of accessing critical data for testing and other processes by product original equipment manufacturer;

FIG. 4 is a diagram of using an OTP memory based on the example method and other memory for different stages in a product life cycle;

FIG. 5A is a table of example data fields stored in a vendor partition of the example OTP memory;

FIG. 5B is a table of example data fields stored in an OEM partition of the example OTP memory;

FIG. 6A is a block diagram showing a patch that switches to patched trim values from an alternative storage source; and

FIG. 6B is a block diagram showing a patch that accesses patch trim values stored in the example OTP memory.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### DETAILED DESCRIPTION

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements, and limitations that are disclosed, for example, in the Abstract, Summary, and Detailed Description sections, but not explicitly set forth in the claims, should not be incorporated into the claims, singly, or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward a one time programmable (OTP) memory that allows flexibility of a microcontroller to access different sets of data for operation of a system on chip device and other components. Bits of a monotonic counter may be set in the example OTP memory to allow access to the OTP memory or another memory device for access to critical system data, such as trim values, and security data, such as access keys or cryptographic keys. The example process leverages both a true OTP memory as well as alternative storage such as a non-volatile memory (NVM) and secure hardware controls. Thus, the source of trim/security information can be selected to be pulled from either an alternative storage source such as an NVM or the OTP memory itself. Selection is controlled by a monotonic counter in the OTP memory that has incremental bits that may be written to select the source. This selector is coupled with lifecycle state management of the device under test. This selection can be switched to and from the alternative storage source back to or from the OTP memory as needed to access different sets of critical data. This is all under access control via security permissions. This allows both silicon device vendors and product OEMs flexibility to change critical values in different stages of a product lifecycle such as testing, during production, or during an RMA process.

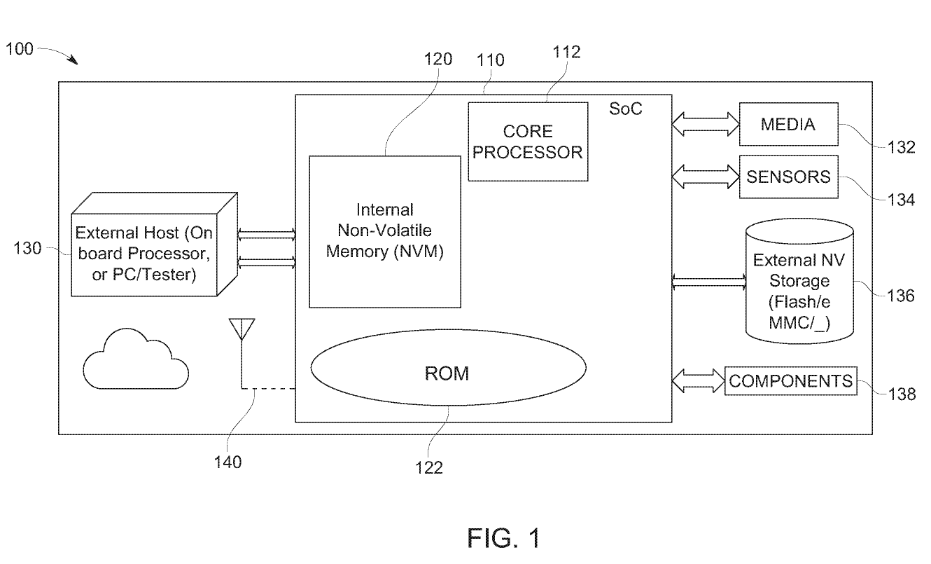

FIG. 1 shows a block diagram of a product 100 with a system on chip device 110. In this example, the product 100 is a low energy system that relies on different programmed functions performed by the system on chip device 110. The system on chip device 110 includes a core processor 112 and non-volatile memory 120 that is a magneto-resistive RAM (MRAM). The system on chip device 110 is generally produced by a silicon vendor. The system on chip device 110 also includes permanent memories such as a read only secure boot read only memory (ROM) 122. In this example, the system on chip 110 is installed in the product 100 by a product OEM. The core processor 112 executes applications generally stored in the non-volatile memory 120 to operate the product 100 to perform different functions.

The product 100 may include an external host processor 130 that controls the functions of the system on chip device 110, which may be connected via wired interfaces such as UART, SPI, or I2C interfaces. The system on chip device 110 controls and accesses a set of components on the product 100 that may include media devices 132 such as a display or an audio output, sensors 134, a non-volatile (NV) memory device 136 such as MSPI Flash or eMMC, or other components 138. As will be explained the NV memory device 136 serves as an alternate storage device for storing a recovery image. The host processor 130 could be coupled to a wireless interface 140 such as Bluetooth or Wifi that allows communication with external components to the product 100. A battery provides power to the components of the product 100 including the system on chip device 110.

Although not all of the electronic components illustrated in FIG. 1 may be operable in the sub-threshold or near-threshold domains in any particular embodiment, some, at least, may be advantageously adapted to do so, with concomitant reductions in system power dissipation. The operation of the electronic components may be tuned through trim values that further allow efficient operation of such components.

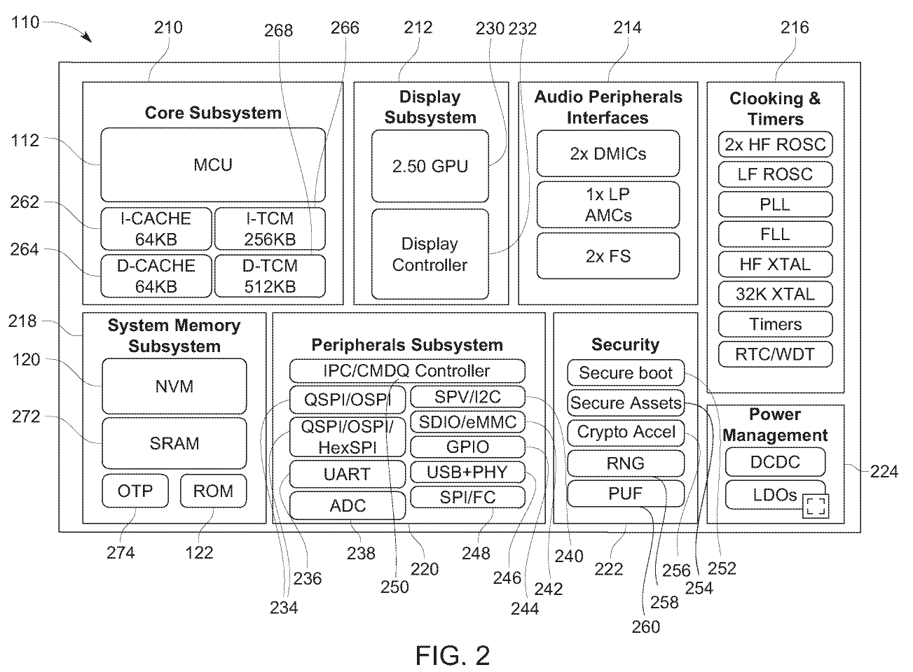

FIG. 2 shows a block diagram of the system on chip device 110 in FIG. 1. The system on chip device 110 includes a core subsystem 210, a display subsystem 212, an audio peripherals subsystem 214, a clock and timers subsystem 216, a memory subsystem 218, a peripheral subsystem 220, a security subsystem 222, and a power management subsystem 224. The display subsystem 212 includes a graphic processor 230 and a display controller 232 to drive displays on the product 100. The audio peripherals subsystem 214 includes different audio peripheral interfaces for driving audio components on the product 100. The clock and timers subsystem 216 includes timers and clocks for the system on chip device 110.

The peripheral subsystem 220 includes different interfaces such as QSPI/OSPI/HexSPI interfaces 234, UART interfaces 236, analog to digital converters 238, SP/I2C master interfaces 240, SDIO (Secure Digital Input Output)/MMC (Multi-Media card) interfaces 242, a set of general purpose input/output (GPIO) pins 244, a USB interface 246, and a SPI slave interface 248. The peripheral interfaces are managed by a peripheral controller 250 that manages inter process communication (IPC) and a command queue (CMDQ). The security subsystem 222 includes a secure boot 252, security assets 254, a crypto accelerator 256, a random number generator (RNG) 258 and a physical unclonable function (PUF) 260. The power management subsystem 224 includes power sources such as low drop out (LDO) and DC power regulator supply sources.

The core subsystem 210 includes the core processor 112 that may be any suitable processor, microcontroller, and the like. In this example, the core processor 112 is an ARM Cortex MCU, but any suitable programmable controller or processor may be used. The core subsystem 210 includes an instruction cache 262 and a data cache 264. The core subsystem 210 includes an instruction tightly controlled memory (TCM) 266 and a data TCM 268. The memory subsystem 218 includes synchronous static random access memory (SSRAM) 272, a one-time programmable (OTP) memory device 274, and the read only memory (ROM) 122. In this example, the OTP device 274 is an e-fuse but other types of OTP memories may be used. The OTP memory 274 stores data such as trim values that may written as a result of production testing and is read by the core processor 112 for tuning components such as the example adaptable voltage converter. As will be explained below, the OTP memory also includes a monotonic counter that allows setting access to either the OTP memory 274 or another memory for reading critical data by writing the bits in the counter. The memory subsystem 218 also includes the non-volatile memory 120, which is MRAM in this example.

The power management subsystem 224 includes voltage converters. The power management subsystem 224 provides voltage to both digital modules such as the core subsystem 210 and analog modules such as the clocking and timers subsystem 216 and analog to digital converters (“ADC”) in the peripheral subsystem 220, and the like. The power management subsystem 224 includes reference voltage generators and reference current generators. The reference voltage generator and reference current generator are each common modules for supplying a stable reference signal to analog modules on the system on chip device 110. The reference voltage generator is sometimes used to derive the output reference current provided by reference current generator.

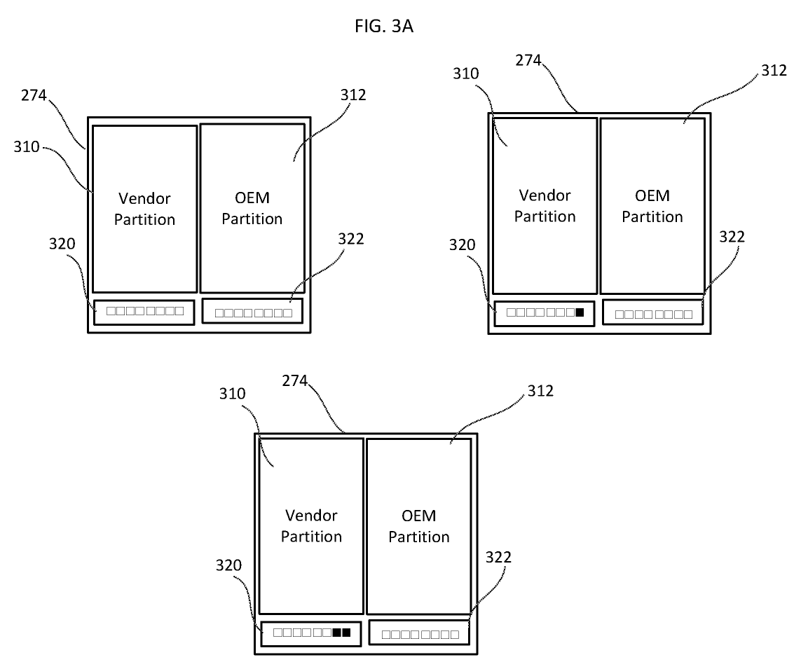

FIG. 3A shows a diagram of the example OTP memory 274. In this example, the OTP memory 274 includes a first partitioned area 310 and a second partitioned area 312. Thus, a silicon vendor of a system on chip device such as the system on chip device 110 can write critical data such as trim values and security data into the first partitioned area 310. For example, security data may include access codes, cryptographic keys, configuration for a wired interface update of the device firmware, version information for the secure boot loader firmware, device recovery configurations, and the like. Such critical data may be proprietary or otherwise only known by the vendor. Another party such as OEM of the product 100 may access the second partitioned area 312 to write critical data such as trim values and security data into the second partitioned area 312. Such critical data may be proprietary or otherwise only known by the OEM. Each of the partitioned areas 310 and 312 have an associated monotonic counter 320 and 322 respectively. The value of the monotonic counter 320 or 322 indicates whether a device such as a processor or controller reading the OTP memory 274 should read the critical data in the respective partition 310 or 312 or reference critical data stored in an alternate storage such as an external NVM. Each counter 320 or 322 includes a sufficient number of one time writable bits to encompass numerous stages in a product lifecycle. In this example, an even value of the counter 320 or 322 indicates reference to critical data stored on an alternative storage device while an odd value of the counter 320 and 322 indicates reference to critical data stored in the partition. Thus, each time the next bit of the counter is written, the counter will be an even or odd value and the source of the critical data is switched between an alternative storage device and the OTP memory or visa versa based on that value.

In this example, each of the counters 320 and 322 have eight bits to allow eight different switches of data sources in a product lifecycle. In this example, the partitions 310 and 312 each allow storing 32kb of data. Of course, the storage of the partitions 310 and 312 may be of any convenient larger or smaller size depending on the size of the critical data required. In this example, the partitions 310 and 312 may be designed with both standard data fields and data fields for data that may be defined by a silicon device vendor or a product OEM based on the system on chip device, the product, or other considerations.

In the first example in FIG. 3A, the value of the counter 320 is even (no bits written) and thus critical data would be accessed from an NVM accessed by the vendor. The critical data may be for vendor specific purposes such as for initial testing. In a second example, the silicon on chip device may be deployed and thus the first bit is written resulting in an odd value of the counter 320. Thus, critical data of the vendor would be read from the partition 310. In a third example, a second bit is written in the counter 320, resulting in an even value for the counter 320. This may be when the device is subject to an RMA process. Thus, critical data of the vendor would be read from an external memory such as an NVM.

FIG. 3B shows the setting of the counter 322 for OEM related data. In the first example in FIG. 3B, the value of the counter 322 is even and thus critical data would be accessed from an NVM accessed by the OEM. The critical data may be for initial testing for components of interest for the OEM. In a second example, the product may be deployed and thus the first bit is written resulting in an odd value of the counter 322. Thus, critical data of the OEM would be read from the partition 312 of the OTP memory 274. In the second example, the first bit of the counter 320 has been written and thus vendor data normally stored in the partition 310 may be accessed through an external NVM controlled by the vendor such as an update provided to a shipped product with the system on chip. In a third example, a second bit is written resulting in an even value for the counter 322. This may be when the device is subject to an RMA process conducted by the OEM. Thus, critical data from the OEM would be read from an external memory such as an NVM for the RMA process.

The counts of the counters 320 and 322 in the example OTP memory 274 allowing leveraging both true OTP memory and external non-volatile memory for storing secure hardware control data. The source of trim/security information can be selected to be pulled from either an alternative memory such as an NVM or the OTP memory itself by setting the bits of the counters 320 and 322.

Selection of a storage source for critical data is controlled by a monotonic counter or counters in the OTP memory to determine which source is to be accessed. This selector is coupled with lifecycle state management of the device under test for access control security policy. This selection can be switched back and forth between OTP memory and an alternative memory as needed if allowed based on the lifecycle state of the device. The entire process is under access control via security permissions. Access to the silicon vendor specific counter 320 and corresponding partition 310 can only be accessed by the silicon vendor since the lifecycle state during this phase of development would be in a “CM state” (Chip Manufacturer) and thus the hardware of the device 110 enforces write and read access to this collateral by comparing the lifecycle state and permissions of the corresponding partition. The OEM specific counter 312 and corresponding partition 312 can only be accessed by the OEM since the lifecycle state during this phase of development would be in “DM state” or Device Manufacturer and hardware enforces write and read access to this collateral by comparing the lifecycle state and the permissions of the corresponding partition. ** A portion of the OTP memory 274 is dedicated to a vendor patch region 330 and an OEM patch region 332. The patch regions 330 and 332 are used for patches to different critical data while the product 100 is in the field as will be explained below.

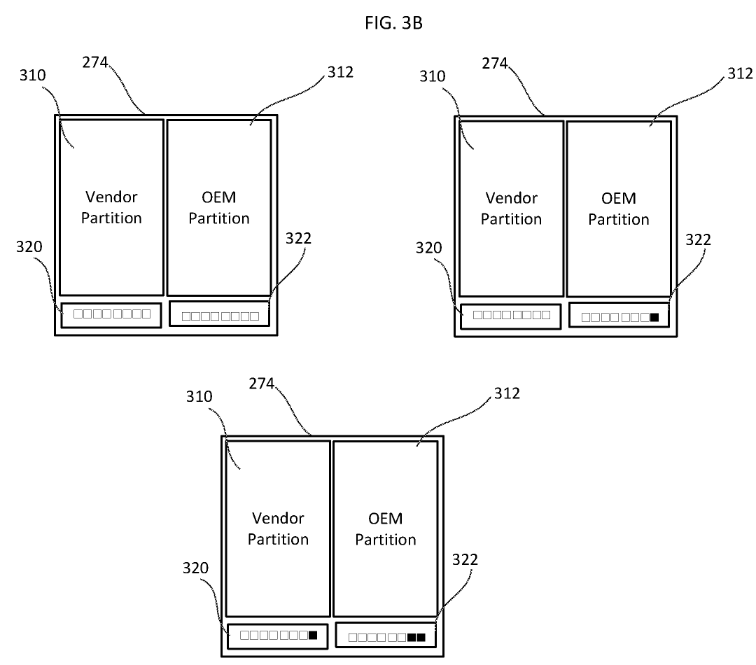

FIG. 4 is a chart that shows an example product lifecycle and corresponding settings of the monotonic counter to access critical data from either the OTP memory or an alternative source such as a NVM. A first stage is an un-provisioned silicon device stage 410. The un-provisioned device stage is where the system on chip device initially is received from the integrated circuit manufacturing process in an untrimmed state. This represents the native state of the system on chip device offered by the silicon chip vendor. In this example, the vendor trims are sourced from external memory (412). The OEM trims are trims sourced from external memory (414). In this instance, the OTP memory counters are set to even by not writing the bits.

A second stage 420 is the silicon vendor trimming the system on chip device where the system on chip goes through testing and validation before being shipped to the product OEM. During testing, vendor specific trims can be multi-programmed from an external source (422) to determine the trim values for the final state for production. Since multiple iterations of testing and changing vendor trims are likely required during this phase, an alternative memory such as an external storage source is used for the trim data. After completion of testing and validation, the final vendor trim configuration data is stored in the vendor partition the OTP memory (422) and a bit is written in the vendor counter to change the counter value to odd. This directs the processor core to access the OTP memory for critical data such as security data or trim data during future operation. Any applicable OEM trim data is generally provided from an external source (424) as the OEM counter is still an even count.

A next stage 430 is manufacturing the OEM product with the system on chip device from the vendor. During the manufacturing stage 430, the system on chip device is assembled with the OEM product and undergoes testing and provisioning. The silicon vendor trims are sourced from those stored in the OTP memory (432). During testing, OEM specific trims can be multiple programmed to determine the final trim state for production of the product. This stage therefore generally uses trims provided from an external source such as an NVM (434). Multiple iterations of testing and changing OEM trims thus require the flexibility of different values stored in the NVM. Once testing is completed, the final trim configuration data is stored in the OEM partition of the OTP memory. The bit for the OEM partition counter is written to change the counter value to odd. This directs the processor core to access the OEM partition of the OTP memory for critical data such as security data or trim data for future operation.

A fourth stage 440 is where the secured system on chip device and product are in production. In this stage, generally data is provided from both the vendor partition (442) of the OEM partition (444). The system on chip device may utilize both sets of trims to determine the final configuration to apply to the hardware components. This allows the silicon device vendor to establish a set of defaults or restrictions and the product OEM to update the defaults as required or if applicable. Vendor and/or OEM trims may need to be updated while the product is in the field. In this example, patches may be offered by either the vendor (446) or the OEM (448). In either case, another bit in the counters in the OTP memory may written to produce an even counter value. This instructs the core processor to access critical data stored in an external source that stores the patch. Updating critical data such as trims is handled securely via a secure patch to ensure integrity of product trims in the OTP memory. Either vendor or OEM trim data may be switched to or from an external source such as an NVM from or to the OTP memory if needed and/or may utilize OTP memory patching as will be explained below.

A final stage 450 is a return merchandise authorization (RMA) process where a product with the system on chip device may be returned to the OEM from a customer. In this stage, vendor and/or OEM trims may need to be updated during testing of a malfunctioning part during the RMA process. The trims are thus accessed through an external source by updating the counter in the OTP memory by writing a bit in the counter to produce an even counter value for accessing vendor trims (452) or OEM trims (454). Switching back to an external source such as an NVM may help with easier trim updates and/or OTP memory patching, which could be leveraged in this stage to assist in the RMA testing and analysis.

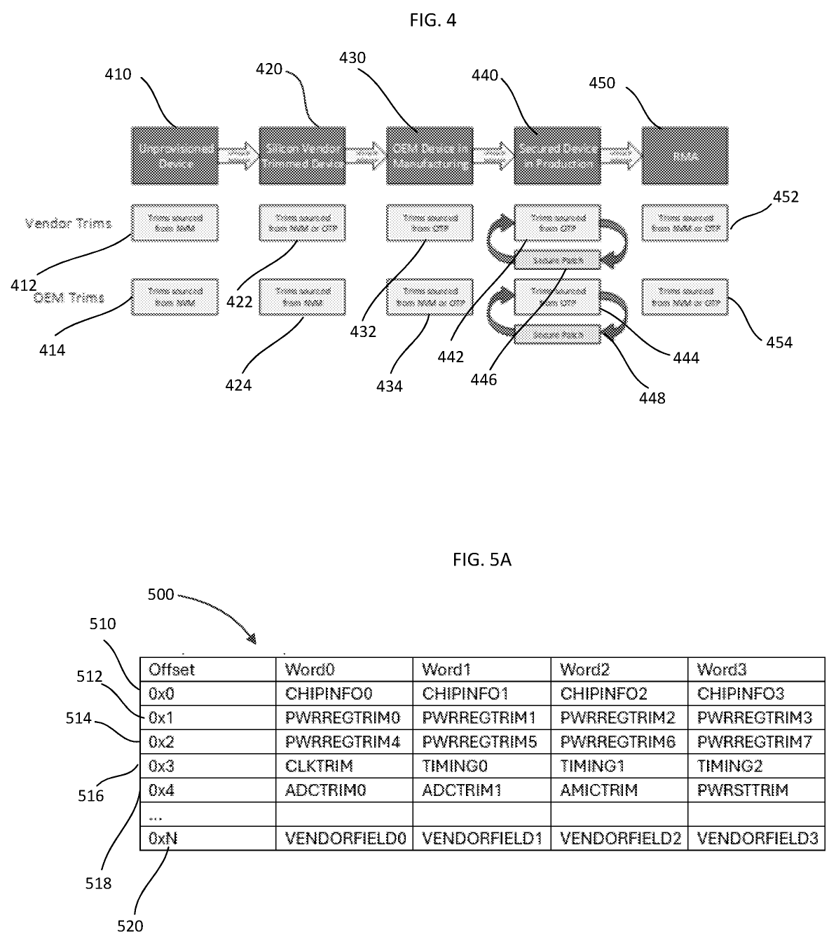

FIG. 5A is a table 500 showing an example of standard data fields that may be accessed by the silicon device vendor in the partition 310 in FIG. 3A. In this example, the table 500 includes a first set of words 510 that include the chip information, and a second and third row of words 512 and 514 include power regulator silicon trim values. In this example the rows of words 512 and 514 stored eight different power regulator trim values. A fourth set of words 516 includes a clock silicon trim value, and timing delay values. Another set of words 518 includes analog to digital converter (ADC) trim values, an analog microphone (AMIC) trim value and a power state trim value that regulates switches to different power sources. A last set of words 520 may be defined by the silicon device vendor. The last set of words 520 may be used for vendor defined purposes such as a test and manufacturing scratchpad.

FIG. 5B is a table 550 showing an example of standard data fields that may be accessed by the OEM in the partition 312 in FIG. 3A. In this example, the table 550 includes a first set of words 560 that include the chip information. A second row 562 includes timing parameters for ADCs, a AMIC trim value, and the power state configuration. In this example, the power state configuration is a complement from the power state configuration in the vendor partition. For example, silicon vendor trims may be used to establish a default value that the OEM can adjust. Alternatively, the silicon vendor trims may be used as a restriction where the OEM cannot override regardless of the OEM trim settings. An example would be a product configuration where the chip device vendor disables the hardware feature on the chip and OEM is not able to enable the hardware features. Another example would be a delay parameter where the device vendor sets the recommended trim parameter value but the OEM can adjust the parameter as needed through a trim stored in the OEM partition. Other parameters such as timing parameters for device or board specific functions may be stored in the data fields. Another set of rows of words 564 may be defined by the OEM. The OEM defined words may be used for OEM defined purposes such as a scratchpad.

As explained above, in the production stage, patches may be periodically applied to update trims. The example OTP memory may be used in the patch process where the hardware may receive a command to apply a patch. In this instance, all the hardware trims stored in the OTP memory are first loaded into internal registers as part of the boot process of the system on chip device. In this example, within the OTP memory partition regions, there are N number of address/data pairs used for patching. After loading the initial trims in the internal registers, the hardware scans the patching region of the OTP memory until it reaches an unprogrammed value stored in the OTP. For each address/data pair, the hardware updates internal registers, which store the OTP values once the device boots up, for the corresponding OTP memory field (based on the address offset value) with the data value. This allows any OTP memory field to be updated as many times as can be supported based on the total OTP region capacity. Updates to the OTP memory patch region are restricted (in hardware) to a secure boot agent which has been authenticated as part of the secure patch flow. Alternatively, the patch may direct the hardware to access new trim values from an external source by incrementing the counter in the OTP memory.

When a patch is received, the device hardware scans the patch region of the OTP for patches to apply after a reboot. For example, a patch may access one of stored trim values for a power regulator in rows 512 and 514 of the table 500 in FIG. 5A. In this example, the trim values in rows 512 and 514 are loaded into internal registers during the boot process. After receiving the secure patch, the hardware scans the addresses corresponding to the trim values for an unprogrammed value such as trim value 5 in FIG. 5A. The hardware may select trim 5 from row 514 to be stored in the internal register to adjust the trim to the power regulator after reboot.

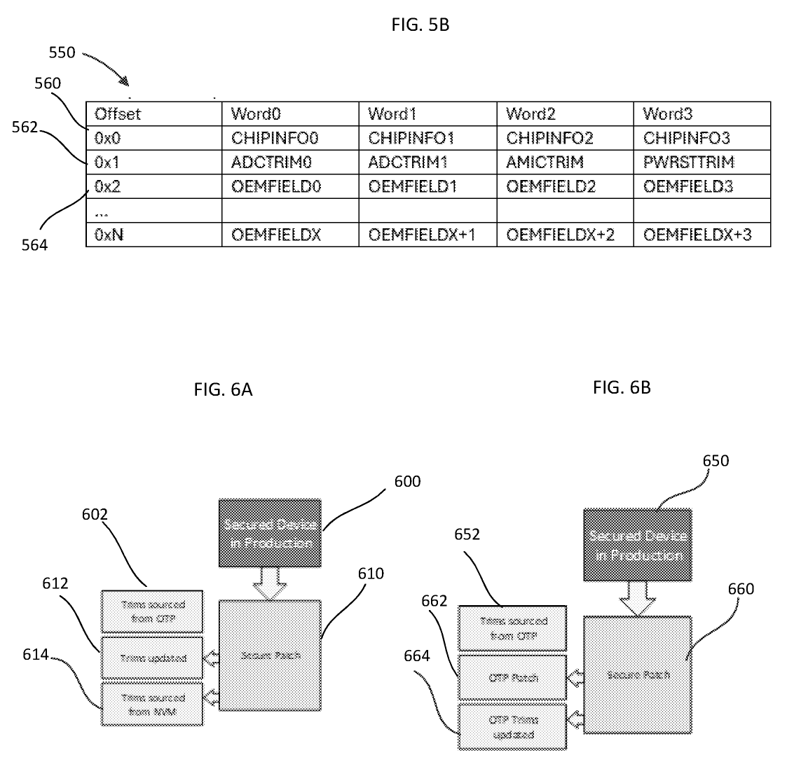

FIG. 6A shows the process of applying a patch to switch to a new trim stored in an external source such as an NVM. In FIG. 6A, a secured device in production 600 includes an OTP 602 that includes different trims. In this example, the device in production 600 may access a secure patch 610. The secure patch 610 will include instructions to update the trim (612). This will write the next counter bit to increment the counter in the OTP memory to an even value and thus an external source (614) defined by the patch. The hardware will access the external source 614 for trims on subsequent boot ups. This process may be used in production as well as typically during the initial manufacturing lifecycle or during RMA, as it allows repeated changes and experimentation by switching to alternate trim space in NVM.

FIG. 6B shows another process of applying a patch to switch to a new trim that is stored in the OTP memory. In FIG. 6B, a secured device in production 650 includes an OTP memory 652 that includes different trims. In this example, the device in production 600 may access a secure patch 660. Since the patched trim is stored in the OTP, the hardware does not write to change the counter value. The secure patch 660 will include instructions to update the trim using an OTP patch (662). The hardware will thus access the fields in the OTP memory (664) for updated trims on subsequent boot ups. This process thus is more appropriate for patches applied during production.

While various embodiments of the present invention have been described above, it should be understood that they have been presented by way of example only, and not limitation. Numerous changes to the disclosed embodiments can be made in accordance with the disclosure herein, without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations, and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

Each of these embodiments and obvious variations thereof is contemplated as falling within the spirit and scope of the claimed invention, which is set forth in the following claims.

What is claimed is:

1. A one time programmable memory device comprising:
a first partition storing a first set of critical data; and
a first monotonic counter including a plurality of bits that may be incrementally written to direct reading the first set of critical data from the first partition or reading a second set of critical data from an alternative memory device.

2. The one time programmable memory device of claim 1, wherein the alternative memory device is a non-volatile memory.

3. The one time programmable memory device of claim 1, wherein the alternative memory device is one of a memory on a system on chip, the system on chip including the one time programmable memory, or a memory external to the system on chip.

4. The one time programmable memory device of claim 1, wherein the first set of critical data includes one of device trim values or security information, and wherein the second set of critical data includes different one of device trim values or security information.

5. The one time programmable memory device of claim 4, wherein the device trims include trims for one of an analog to digital converter, a microphone, a power regulator, or a clock.

6. The one time programmable memory device of claim 4, wherein the security information includes one of an access code, a cryptographical key, a configuration for an update of device firmware, version information for a secure boot loader firmware, or a device recovery configuration.

7. The one time programmable memory device of claim 1, further comprising:
a second partition storing a third set of critical data; and
a second monotonic counter including a plurality of bits that may be incrementally written to direct reading the third set of critical data from the second partition or reading a fourth set of critical data from an alternative memory device.

8. The one time programmable memory device of claim 7, wherein the first partition is accessible by a system on chip vendor and the second partition is accessible by a product OEM.

9. The one time programmable memory device of claim 1, wherein the one time programmable memory device is an e-fuse.

10. The one time programmable memory device, wherein the first partition stores an address to a patch trim for one of a plurality of stored trims, wherein a patch is received by a hardware device that accesses the one time programmable device and accesses the patch trim.

11. A method of determining a location of critical data for a system on chip device including a microcontroller and a one time programmable device including a first partition and a first monotonic counter including a plurality of bits, the method comprising:
writing a first set of critical data in the first partition;
writing a first bit in the monotonic counter to set a first counter value;
based on the first counter value, accessing the first set of critical data in the first partition by the microcontroller;
incrementally writing a second bit in the monotonic counter to set a second counter value; and
based on the second counter value, accessing a second set of critical data from an alternative memory device by the microcontroller instead of the first set of critical data in the first partition.

12. The method of claim 11, wherein the alternative memory device is a non-volatile memory.

13. The method of claim 11, wherein the alternative memory device is one of another memory on the system on chip or a memory external to the system on chip.

14. The method of claim 11, wherein the first set of critical data includes one of device trim values or security information, and wherein the second set of critical data includes different one of device trim values or security information.

15. The method of claim 14, wherein the device trims include trims for one of an analog to digital converter, a microphone, a power regulator, or a clock, and wherein the security information includes one of an access code, a cryptographical key, a configuration for an update of device firmware, version information for a secure boot loader firmware, or a device recovery configuration.

16. The method of claim 11, further comprising:
storing a third set of critical data in a second partition of the one time programmable device; and
incrementally writing a bit of a second monotonic counter including a plurality of bits to direct reading the third set of critical data from the second partition or reading a fourth set of critical data from an external memory device.

17. The method of claim 16, wherein the first partition is accessible by a system on chip vendor and the second partition is accessible by a product OEM.

18. The method of claim 11, wherein the one time programmable memory device is an e-fuse.

19. The method of claim 11, further comprising:
storing an address to a patch trim for one of a plurality of stored trims; and
on receiving a patch, accessing the patch trim.

20. A system on chip device comprising:
a microcontroller; and
a one time programmable memory device accessible by the microcontroller, the one time programmable memory device including:
a first partition storing a first set of critical data;
a first monotonic counter including a plurality of bits that may be incrementally written to direct the microcontroller to read the first set of critical data from the first partition or read a second set of critical data from an alternative memory device.
